(19) United States
(12) Patent Application Publication
(10) Pub. No.: US 2026/0145286 A1
(43) Pub. Date: May 28, 2026

(54) INTERNAL PALLET LOADER FOR CNC MACHINE

(71) Applicant: Michael Gimbel, Alhambra, CA (US)

(72) Inventor: Michael Gimbel, Alhambra, CA (US)

(21) Appl. No.: 19/401,217

(22) Filed: Nov. 25, 2025

Related U.S. Application Data
(60) Provisional application No. 63/726,313, filed on Nov. 28, 2024.

(51) Int. Cl. B23Q 7/04

(52) U.S. Cl. CPC B23Q 7/046

(57) ABSTRACT

The present invention provides an internal pallet loader for a CNC machine, comprising: a pallet gripper mounted to a CNC mill; one or more of a pneumatic, hydraulic, or electric actuator for the pallet gripper; and a pallet tray, wherein the actuator is configured to move the pallet gripper to reach the pallet tray and exchange pallets between the tray and the worktable.

### BACKGROUND

Computer Numerical Control (CNC) machines are utilized in machining processes, and utilize a computer controller that typically reads G-code instructions for driving a powered mechanical device that is used to fabricate metal components by the selective removal of metal. In a CNC milling machine, it is common practice for operators to use their hands to load and unload material into and out of a clamping device affixed to the machine table that will be cut down to size in the machine.

Therefore, during operation of CNC machines, manual regular loading and unloading of stock to be machined may be required. A variety of methodologies have been applied in order to supplant operators manually loading and unloading this kind of machinery. For example, a gripper for loading and unloading material into and out of a clamping device can be attached to a spindle and operated automatically according to a work coordinate system.

Traditional pallet loading systems often consist of an external machine or apparatus attached to the CNC machine. These systems can vary in size, shape and means of pallet conveyance. Some of these systems exchange the entire machine table, while others exchange workholding devices, while still others use robotic manipulators.

A common feature of traditional pallet loading systems is that they add significant mechanical complication to a CNC machine and also take a large amount of space to implement and make safe for human operators. The key feature to all pallet loading systems is that they allow for operators to load blank stock into workholding concurrently to the CNC machine producing components.

However, prior art devices are lacking in ability to handle pallets, among other limitations.

### SUMMARY OF INVENTION

The present invention provides a pallet loading system that is completely internal to the CNC machine, comprising: a pallet gripper mounted to a CNC machine; one or more of a pneumatic, hydraulic or electric actuator to move the pallet gripper in one or more degrees-of-freedom; and a pallet tray, wherein the actuator is configured to move the pallet gripper to reach the pallets located atop the pallet rack, such that the pallets can be loaded onto the machine table automatically and with a high degree of repeatability.

### BRIEF DESCRIPTION OF THE DRAWINGS

FIG. 1 is perspective view of the pallet loader according to the present invention in a retracted position;

FIG. 2 is a perspective view of the pallet loader according to the present invention in an extended position, placing a pallet onto the work table of the CNC Machine;

FIG. 3 is a view of the pallet loader and modular tray system for holding pallets;

FIG. 4 is a detailed view of the pallet gripper actuator in a retracted position, both with and without protective covers shown;

FIG. 5 is a detailed view of the pallet gripper actuator in an extended position, both with and without the protective covers shown; and

FIG. 6 is a detailed view of the pallet shelf rack with the protective cover in a retracted position.

FIG. 7 is a flow diagram depicting the steps that take place during an automated pallet change cycle.

### DETAILED DESCRIPTION

Clearances and collision avoidance is a major issue in CNC machines, particularly with five axis CNC machines which have motion components that can tilt, rotate and translate in the x, y, and z directions. An internal pallet gripper attached to the machine spindle or to the spindle housing would crash into the CNC machine's work table, the CNC machines internal kinematics, or to the zero-point pallet workholding system if it lowered to reach a pallet stored in the zero-point pallet workholding system or if it were to reach the pallets atop the pallet trays.

The present invention provides a solution to this issue. According to the present invention, an actuator is provided for a pallet gripper which toggles the pallet gripper between two states: Extended and Retracted. One such embodiment moves the pallet gripper along a track e.g., down along the z direction to reach pallets stored in the trays and to reach pallets that are on the zero-point workholding system mounted to the machine table,

e.g., on the side of a CNC machine spindle housing in order to avoid the CNC machine's spindle from crashing into the zero point. In some other embodiments of the present invention, the pallet gripper does not run along a track, but instead is mounted to a rotary actuator, such that the pallet gripper is rotated (usually 180 degrees) such that is at a similar or lower height to the spindle housing, thus allowing access for the pallet gripper to grip pallets located either on the zero-point chuck system or atop the pallet trays. In certain other embodiments, rather than an actuator that is only capable of two states (such as extended and retracted), a ballscrew, screw, belt, or other motorized actuation is used, therefore allowing infinitely-adjustable positioning.

Additionally, the present invention increases the amount of pallets and thus raw stock which can be prepared for processing by allowing for additional levels of pallets to be stored on a modular tray system, reducing the requirements for manual regular loading and unloading of stock to be machined with attendant cost and productivity advantages. In embodiments utilizing a linear actuator to move the pallet gripper, one or more additional rows of pallets can sometimes be added by utilizing the additional travel in the Z direction of the machine of the said linear actuator, in addition to the Z travel inherent to the Spindle Head's movement in the machine. In some embodiments utilizing a rotary actuator to bring the pallet gripper into an operational position, pallets may be stored upside down on the additional rows on the pallet rack, such that they are right-side-up once the pallet-gripper is moved into the normal operational position (i.e. in the extended position).

In some embodiments, the entire pallet shelf system is a rotating carousel, presenting a single column of pallets to the pallet loader as well as a separate single column of pallets to the exterior of the machine for operator access and changeover. In some other embodiments, the entire rotary carousel shelf system is actuated in one or more linear degrees of freedom. For instance, the carousel could be actuated in the X negative direction in order to bring the pallet shelves into range of the pallet loader. In some instances of the rotary actuator, the motion might be achieved by a geared connection, a belted connection, and/or a mechanism for finite indexed positions in the range of the rotary motion.

The pallet gripper is controlled by one or more of: pneumatic, electric, hydraulic or passive actuation. When the state of the pallet gripper is actively controlled, the status of the pallet gripper can optionally be determined by open-loop, e.g., reading or recording the last commanded state or by a closed-loop method, e.g., by actively reading the status of proximity sensors to determine what state the pallet gripper is in and/or if it completed its change to the commanded state.

In some embodiments, when the pallet gripper is a passively controlled static interface, pallets can be retrieved, placed, and stored using controlled linear motion from the CNC machine that the pallet loader is attached to. In this use case, the pallet gripper interface consists of a pair of cleats with geometry such that a secure connection can be engaged and disengaged with a repeatable move sequence. In some embodiments, this geometry is a pair of complimentary, interlocking, dovetail angles that creates a self-stable connection between the gripper and the pallet. In the case of a passive static gripper mechanism, the weight of the pallet due to gravity along with the geometry of the interface keeps the pallet secure during retrieval, placement or storage movements.

Furthermore, the tray system can be safely accessed and reloaded with additional raw stock while the CNC machine is operating, permitting longer operation time with less CNC machine idle time. The machine's automatic rollup door protects the operator reloading the door during operation from chips and debris.

Additionally, manufacturing floor space and usage is a large driving factor in operating cost and scalability in a manufacturing business. Traditional pallet loading systems can be as large as the CNC machine they are attached to and can present several safety and control integration challenges.

The present invention provides a solution to these problems. According to the present invention, the pallet loading system and tray are completely internal to the CNC machine footprint. The safety and control integration is made simpler by means of using the CNC machine kinematics and control software to change states of the pallet loading actuator, the pallet gripper and the movement to the pallet trays and zero-point workholding system. The safety inherent in the CNC machine to prevent operators from interacting with the machine kinematics is unchanged with the internal nature of this invention. Further, since this invention does not require external apparatus or equipment, manufacturing floor space is unchanged when adding this system, and is preserved for additional expansion of equipment.

In some embodiments, a PLC system is present that provides additional functionality and safety to the pallet loader system. When present, the PLC system can aid in scheduling the order in which the pallets are run by the CNC machine. Additionally, the PLC can provide additional safeties to prevent crashes of the machine kinematics into components of the pallet loader, prevent operation of the CNC machine when not in a safe state of the pallet loader, and read sensors related to the pallet loader to ensure correct functions.

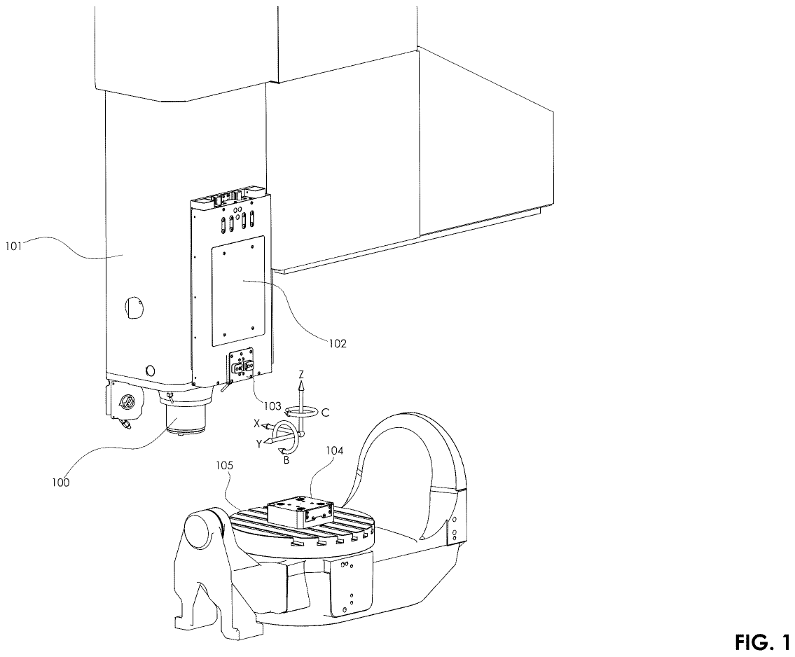

FIG. 1 is a perspective view of the pallet loader according to the present invention in a retracted position. The retracted position is employed when the system is not in use, such as after a pallet is loaded and the machine is processing the raw stock that is secured to the workholding mounted to the pallet base.

CNC machine spindle 100 extends from CNC machine spindle housing 101. Pallet loader 102 is attached to CNC machine housing 101. Pallet loader 102 is on a track which is not visible in the view of FIG. 1 as the pallet loader is fully retracted so as to block the view of the track. One or more of a pneumatic, hydraulic, or electric actuator is coupled with pallet loader 102 to provide locomotion for it. Pallet gripper 103 is attached to pallet loader 102 such that it can be moved into and out of position using one or more of a pneumatic, hydraulic, or electric actuator(s). Zero-point chuck 104 is located on the machine worktable 105, where pallets are to be loaded and subsequently processed by the CNC machine.

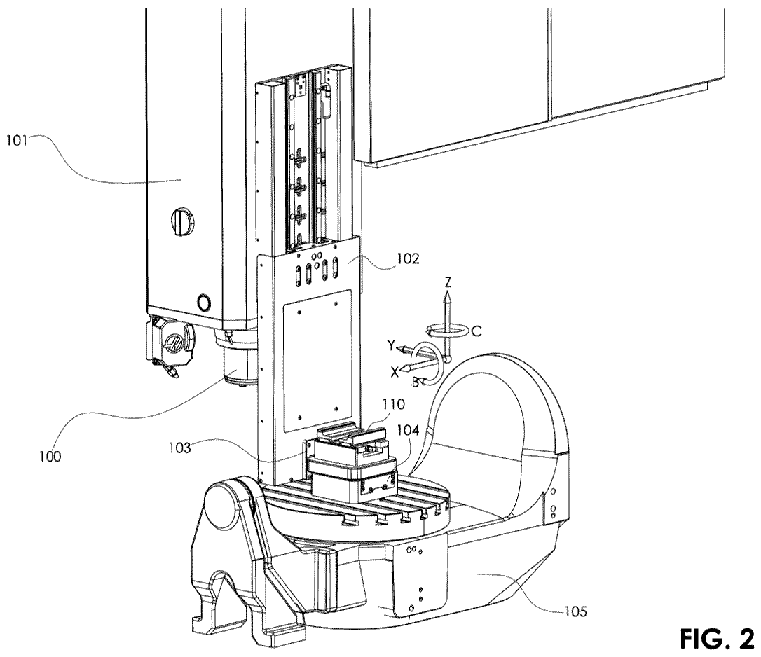

FIG. 2 is a perspective view of the pallet loader according to the present invention in an extended position. The extended position is employed when the system is in active use, such as when the pallet gripper is retrieving a pallet from the modular tray system, or when placing a pallet onto the zero-point chuck.

CNC machine spindle 100 extends from CNC machine spindle housing 101. Pallet loader 102 is attached to CNC machine housing 101. Pallet gripper 103 is moved using one or more of a pneumatic, hydraulic, or electric actuator(s) of pallet loader 102. Pallet gripper 103 grips pallet 110 for conveyance into alignment with zero point chuck 104, atop CNC machine work table 105.

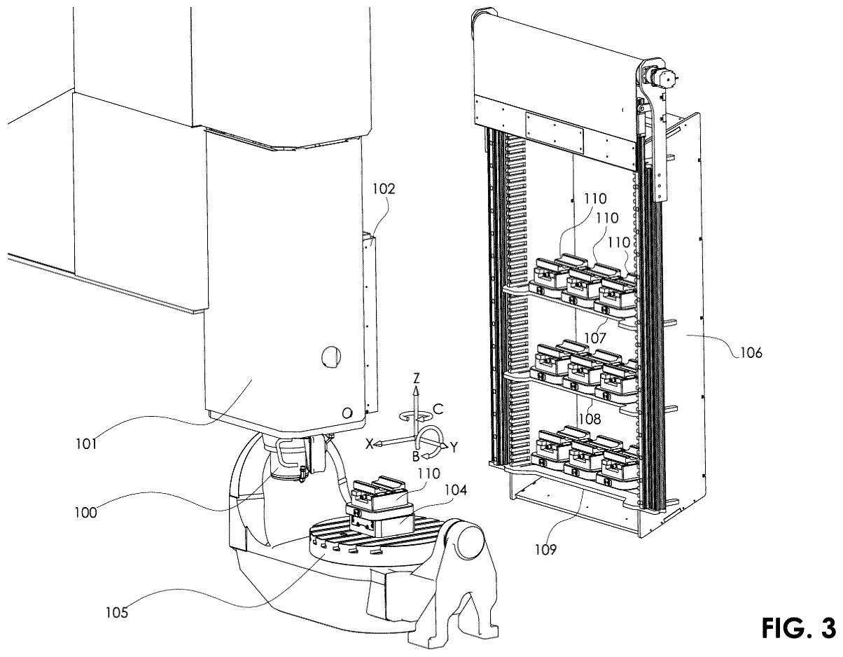

FIG. 3 is a view of the pallet loader and modular tray system for storing pallets to be processed by the CNC machine.

CNC machine spindle 100 extends from CNC machine housing 101. Pallet loader 102 is attached to CNC machine housing 101. One or more of a pneumatic, hydraulic, or electric actuator(s) coupled with pallet loader 102 moves the pallet gripper 103 into position to retrieve pallet 110, which is in place either on zero-point chuck 104 or modular tray system 106.

Pallets 110 are positioned on shelves within modular tray system 106. Modular tray system 106 is configured to have multiple levels of trays. In the view of FIG. 3, tray 107 is the highest level tray. Tray 108 is the middle level tray. Tray 109 is the lowest level tray. More or fewer trays could be used in other embodiments, and they can be placed to accommodate various sizes and shapes of work pieces.

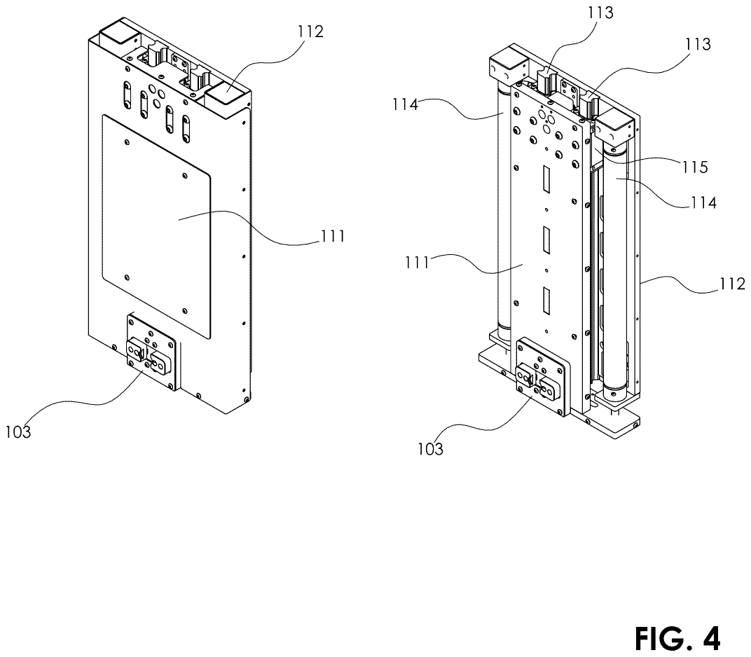

FIG. 4 is a detailed perspective view of the pallet loader according to the present invention in a retracted position. The retracted position is employed when the system is not in active use, such as when the CNC machine is processing or is idle. Protective covers are shown and also hidden to show underlying mechanisms.

Pallet Loader 102 comprises the stationary portion 112 and the moving portion 111. Pallet gripper 103 is attached to the moving portion 111 and is moved using one or more of a pneumatic, hydraulic, or electric actuator(s). In this embodiment, pneumatic cylinders 114 can be actuated to provide motion of the moving portion 111. The moving portion 111 is moved along tracks 113 with guideblocks 115.

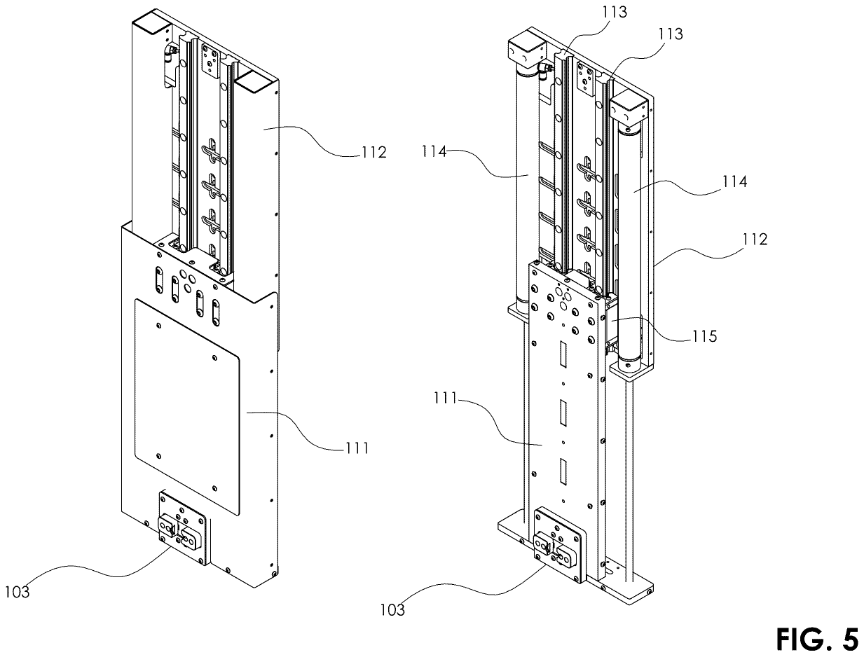

FIG. 5 is a detailed perspective view of the pallet loader according to the present invention in an extended position. The extended position is employed when the system is in active use of retrieving or placing a pallet.

Pallet Loader 102 comprises the stationary portion 112 and the moving portion 111. Pallet gripper 103 is attached to the moving portion 111 and is moved using one or more of a pneumatic, hydraulic, or electric actuator(s). In this embodiment, pneumatic cylinders 114 can be actuated to provide motion of the moving portion 111. The moving portion 111 is moved along tracks 113 with guideblocks 115.

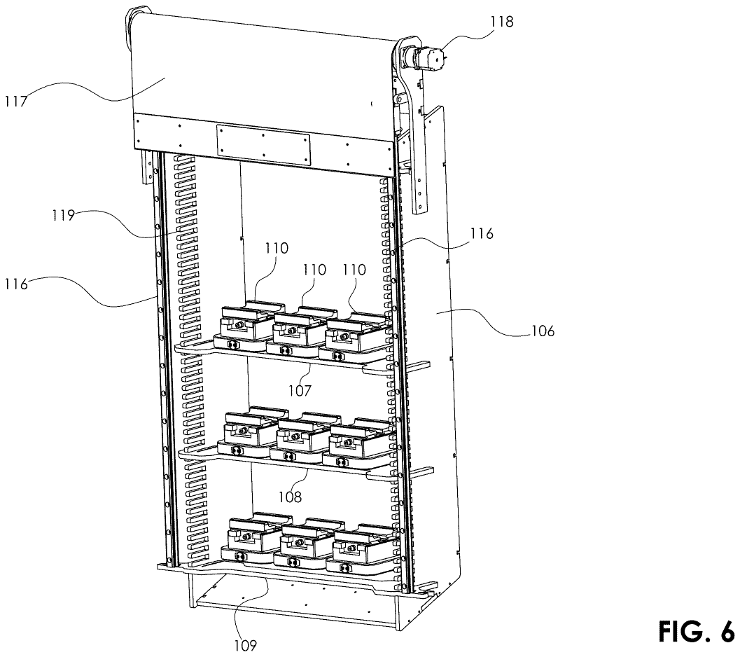

FIG. 6 is a detailed perspective view of the modular pallet rack according to the present invention.

Pallets 110 are positioned on shelves within modular tray system 106. Modular tray system 106 is configured to have multiple levels of trays, selectable using indexed positions 119. In the view of FIG. 6, tray 107 is the highest level tray. Tray 108 is the middle level tray. Tray 109 is the lowest level tray. More or fewer trays could be used in other embodiments, and they can be placed to accommodate various sizes and shapes of work pieces. Chip guard 117 is moved along tracks 116 by means of motor 118. The chip guard 117 can be extended and retracted in order to provide protection for the pallets from swarf and coolant generated by the CNC machine processes. Additionally, the chip guard 117 allows for an operator to safely access the modular tray system 106 while the machine is in operation, to access pallets 110 in order to retrieve finished components or to reload pallets 110 with new workpieces or fixtures.

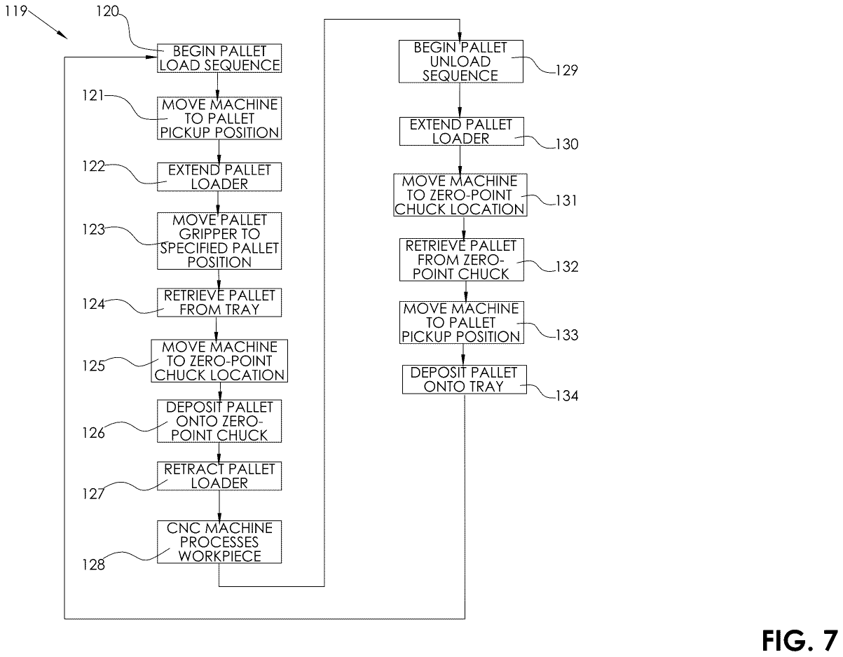

FIG. 7 is a flow chart illustrating the function of the pallet loader system.

Flow chart 119 is depicted in FIG. 7, illustrating the series of events taken by the pallet loader system. Pallet load sequence 120 is called by the CNC machine program. In some other embodiments, the pallet load sequence 120 is called by a PLC pallet management system. Load sequence is followed by the CNC machine moving to the pallet pickup position 121 using the CNC machine motion kinematics. The pallet loader is then extended 122 into the active position. In some embodiments, the pallet loader may be moved into an infinitely adjustable position to access pallets. The pallet gripper is next position to the specified pallet position 123 using the CNC machine motion kinematics. The system then retrieves the pallet 124 from the modular tray system. Once the pallet is gripped, the machine can move to the zero-point chuck location 125 and then deposit the pallet onto the zero point chuck 126. The pallet loader is then retracted 127 to an inactive position, clear of the workpiece and machine motion kinematics. The CNC machine is now prompted to process the workpiece 128. Once CNC processes are complete, the unload pallet sequence can begin 129. The pallet loader is extended into the active position 130. The pallet gripper is positioned to the machine zero-point chuck location 131 and the pallet with the finished workpiece is retrieved 132. The motion motion kinematics are then used to move to the pallet pickup location 133 and then the finished workpiece pallet is deposited onto the pallet tray 134. Once completed, the entire cycle can loop to pallet load sequence 120. This loop may continue as long as pallets are available, the program hits a counter, the PLC pallet manager calls for no more pallets, or an operator decides to end the loop.

The illustrations of embodiments described herein are intended to provide a general understanding of the structure of various embodiments, and they are not intended to serve as a complete description of all the elements and features of apparatus and systems that might make use of the structures described herein.

Many other embodiments will be apparent to those of skill in the art upon reviewing the above description. Other embodiments may be utilized and derived therefrom, such that structural and logical substitutions and changes may be made without departing from the scope of this disclosure.

Figures are also merely representational and may not be drawn to scale. Certain proportions thereof may be exaggerated, while others may be minimized.

Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments.

Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. An internal pallet loader for a CNC machine, comprising: a pallet gripper mounted to a CNC mill; one or more of a pneumatic, hydraulic, or electric actuator for the pallet gripper and a pallet tray, wherein the actuator is configured to move the pallet gripper to reach the pallet tray and/or to reach the pallet on the zero-point chuck system mounted to the machine table.

2. The internal pallet loader for a CNC machine of claim 1, wherein the CNC machine is a five axis CNC machine.

3. The internal pallet loader for a CNC machine of claim 1, wherein the CNC machine is a three-axis machine.

4. The internal pallet loader on a three-axis machine as described in claim three, where one or more additional axes of movement are provided by the addition of a trunnion or rotary table.

5. The internal pallet loader for a CNC machine of claim 1, wherein the actuator moves the pallet gripper in the z direction.

6. The internal pallet loader for a CNC machine of claim 1, wherein the pallet tray comprises shelves with multiple levels configured for storing pallets.

7. The internal pallet loader for a CNC machine of claim 1, wherein the pallet tray mounts to the internal of the sheet metal enclosure of the CNC machine.

8. The internal pallet loader for a CNC machine of claim 1, wherein the pallet gripper avoids crashing into the machine kinematics and/or zero-point workholding system by the movement of the actuator.

9. The internal pallet loader for a CNC machine of claim 6, wherein the number of levels is three.

10. The Internal pallet loader for a CNC machine of claim 1, wherein the system does not alter the overall footprint of the CNC machine.

11. The internal pallet loader for a CNC machine of claim 6, wherein the shelves are on a rotating carousel, presenting a column of pallets to the loader.
